(19) United States
(12) Patent Application Publication
(10) Pub. No.: US 2009/0010326 A1
(43) Pub. Date: Jan. 8, 2009

(54) METHOD AND APPARATUS FOR PARALLEL VIDEO DECODING

(76) Inventors: Andreas Rossholm, Malmo (SE); Johan Svensson, Klippan (SE)

Correspondence Address: ERICSSON INC., 6300 LEGACY DRIVE, M/S EVR 1-C-11, PLANO, TX, 75024, US

(21) Appl. No.: 11/773,626

(22) Filed: Jul. 5, 2007

(51) Int. Cl. H04N 11/02

(52) U.S. Cl. 375/240.03; 375/240.01; 375/240.24; 375/240.16; 375/E07.076

(57) ABSTRACT

A method and apparatus for parallel decoding of a video data stream in a video decoder. A first processor (CPU-1) performs entropy decoding, inverse quantization, inverse transformation, intra prediction, and modified motion compensation on the video data to produce an intermediate data stream. In parallel with CPU-1, the intermediate data stream is provided to a second processor (CPU-2), which performs de-blocking to produce a decoded video data stream, and also performs pre-motion compensation and interpolation to produce interpolated reference frames. CPU-2 stores original frames and interpolated reference frames in a frame buffer. In parallel, CPU-1 selectively reads either the original video reference frames or the interpolated reference frames from the frame buffer prior to performing the modified motion compensation.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to audio and video communication systems. More particularly, and not by way of limitation, the invention is directed to a method and apparatus for parallel decoding in a video decoder suitable for use in a mobile communication device.

FIG. 1 is a simplified block diagram of an existing H.264 video decoder 10. The H.264 decoder is the latest video decoder adopted in the 3GPP specifications. The H.264 is jointly standardized by the International Telecommunication Union (ITU) and the Moving Picture Experts Group (MPEG) in the Joint Video Team (JVT). In a straightforward solution, the H.264 decoder is run on one CPU. However, in some cases co-processors may be used to decrease the computational power required on each CPU, although the processing order is still the same.

The H.264 design is similar to earlier standards in that it is a block-based, motion-compensation, hybrid transform video coder. The H.264 video codec contains a number of features and functionalities that enable it to achieve a significant improvement in coding efficiency relative to previous designs. However, such features and functionalities also increase the complexity in decoding and encoding. This includes increased algorithmic complexity and increased computational complexity and storage requirements. Both the algorithmic complexity and storage requirements determine to a large extent the cost of hardware implementation, mainly because they affect the size of the circuits used in the implementation. The computational complexity primarily affects the execution speed of the algorithms on the hardware system.

Three fundamental steps are performed to increase the compression for a video sequence. The first step, performed before a frame is processed, is a color conversion from RGB to YCbCr, where Y is the luminance component and Cb and Cr represent the color or chrominance difference for blue and red, respectively. Also, due to the fact that the human visual system is more sensitive to luminance than to color, the colors are represented with lower resolution. The second step is to exploit the high redundancy (correlation) between successive frames. This is performed by the motion compensation functionality. The third step to increase compression involves exploiting the spatial redundancy, or high correlation, between pixels in the difference frame. This is performed by intra predictions and transformations.

The video codec also performs quantization, a lossy way to reduce the amount of transform coefficients, and an entropy coder, a lossless compression based on statistical information. The lossy quantization introduces artifacts; therefore the H.264 codec also includes a de-blocking filter to reduce the visual degradation.

An incoming compressed video signal 11 is processed in an Entropy Decoding unit 12, an Inverse Quantization unit 13, an Inverse Transform unit 14, and then enters a loop with a De-blocking Filter 15, a Frame Memory 16, and a Motion Compensation unit 17. A second loop may include an Intra Prediction unit 18. The video decoder outputs a decoded video signal 19.

FIG. 2 is an illustrative drawing of an existing video decoding process. Video streams are decoded at a Macro Block (MB) level, where each MB 21 consists of 16×16 Luminance (Y) 22, one 8×8 Chrominance red (Cr) 23, and one 8×8 Chrominance blue (Cb) 24. Thus, the video decoder decodes the frame 25, MB by MB.

When the coding mode for the MB is inter-coding, a motion prediction is determined by the motion vectors that are associated with the MB. The motion vectors indicate the position within the set of previously decoded frames, located in the frame memory, from which each block of pixels will be predicted. Motion vectors (MVs) are specified with quarter-pixel accuracy. Interpolation of the reference video frames is necessary to determine the predicted MB using sub-pixel accurate motion vectors. To generate a predicted MB using half-pixel accurate motion vectors, an interpolation filter that is based on a 6-taps windowed sync function is employed (with tap values [1, −5, 20, 20, −5, 1]). In the case of prediction using quarter-pixel accurate motion vectors, filtering consists simply of averaging two nearest integer- or half-pixel values, although one of every twelve quarter-pixel values is replaced by the average of the four surrounding integer-pixel values, providing more low-pass filtering than the other positions. A bi-linear filter is used to interpolate the chrominance frame when sub-pixel motion vectors are used to predict the underlying chrominance blocks.

It is known in the prior art that de-blocking filtering and interpolation are two of the most demanding and complex sub-functions for a typical video sequence.

The de-blocking filter reduces blocking artifacts that are introduced by the coding process. The standard specifies that the de-blocking filter be applied within the motion compensation loop; therefore any compliant decoder must perform this filtering exactly. The filtering is based on the 4×4 block edges of both luminance and chrominance components. The type of filter used, the length of the filter, and the strength are dependent on several coding parameters. A stronger filter is used if either side of an edge is a macro-block boundary where one or both sides of the edge are intra-coded. The length of the filtering is also determined by the pixel values over the edge, which determine the so-called “activity parameters”. These parameters determine whether 0, 1, or 2 pixels on either side of the edge are modified by the standard filter.

The computational power of the de-blocking filtering can be separated into two parts: the computation of the strength for each 4-pixel edge and the actual filtering. Since the computation of the strength is generally performed in the same way for every macro-block, the time required for this operation remains relatively constant per macro-block over various types of content and bit rates. At lower bit rates, the complexity of this operation is slightly reduced, since some of the strength computations can be skipped when there are a large number of macro-blocks coded in the SKIP mode, which is a prediction algorithm to reduce the computational effort of video encoders.

Interpolation of both luminance and chrominance samples is generally performed for each INTER coded macro-block. Thus, the average time required for interpolation in the decoder is a direct factor of the number of INTER coded macro-blocks. The complexity of chrominance interpolation is generally half that of luminance, since there are half as many chrominance samples as there are luminance samples in the input data.

Some hardware architectures may contain more than one processor, but in the prior art, only one processor is used for video decoding. This causes inferior decoding performance in terms of spatial resolution, frame rate, and bit-rate in such an architecture.

What is needed in the art is a method and apparatus for parallel decoding in a video decoder that overcomes the problems of the prior art. The present invention provides such a method and apparatus.

### BRIEF SUMMARY OF THE INVENTION

The present invention is directed to a method and apparatus for parallel decoding in a video decoder suitable for use in a mobile communication device. To be able to increase the decoding performance in terms of spatial resolution, frame rate, and bit-rate in a mobile device architecture, it is necessary to utilize more than one processor to perform the video decoding. The present invention utilizes more than one processor to provide a video decoder in a mobile communication device with improved performance over the prior art. The invention enables the design and manufacture of high-end video products without having to add a video hardware accelerator.

In one aspect, the present invention is directed to an apparatus for parallel decoding of a video data stream in a video decoder. The apparatus includes a first processor for performing a first subset of decoding operations to produce a first intermediate result; and a second processor for receiving the first intermediate result from the first processor and for utilizing the first intermediate result as an input for performing a second subset of decoding operations in parallel with the first processor to produce a second intermediate result. The first processor includes means for utilizing the second intermediate result as an input for performing a third subset of decoding operations in parallel with the second processor to produce a decoded video data stream.

In one embodiment, the first processor includes, for example, an entropy decoding unit, an inverse quantization unit, an inverse transform unit, and an intra prediction unit for performing the first subset of decoding operations to produce input data to the de-blocking sub-function. The second processor includes a de-blocking filter and a pre-motion compensation unit for performing the second subset of decoding operations.

The apparatus may also include a frame memory for storing original video reference frames and the interpolated reference frames, and the first processor may include means for selectively reading either the original video reference frames or the interpolated reference frames from the frame buffer. The first processor may also include means for performing modified motion compensation operations on the original video reference frames and the interpolated reference frames.

In another aspect, the present invention is directed to a method of decoding a video data stream in a video decoder. The method includes the steps of performing a first subset of decoding operations in a first processor to produce a first intermediate result; sending the first intermediate result to a second processor; and utilizing the first intermediate result by the second processor as an input for performing a second subset of decoding operations in parallel with the first processor to produce a second intermediate result. The method also includes sending the second intermediate result to the first processor; and utilizing the second intermediate result by the first processor as an input for performing a third subset of decoding operations in parallel with the second processor to produce a decoded video data stream.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 (Prior Art) is a simplified block diagram of an existing H.264 video decoder;

FIG. 2 (Prior Art) is an illustrative drawing of an existing video decoding process, in terms of the macro block decoding order;

FIG. 3 is an illustrative drawing illustrating the division of the Motion Compensation function of a video decoder into two separate functions in one embodiment of the present invention;

FIG. 4 is a simplified block diagram of an embodiment of the apparatus of the present invention;

FIG. 5 is a functional block diagram illustrating the processing flow between CPUs in an embodiment of the method of the present invention;

FIG. 6 is a flow chart illustrating the steps of an exemplary embodiment of the method of the present invention; and

FIGS. 7A and 7B are flow charts illustrating the parallel processes performed in CPU-1 and CPU-2 in an embodiment of the method of the present invention.

### DETAILED DESCRIPTION OF THE INVENTION

The present invention provides a video decoder with improved performance over the H.264 video decoder in a mobile communication device that uses more than one processor. The invention enables the design and manufacture of high-end video products without having to add a video hardware accelerator.

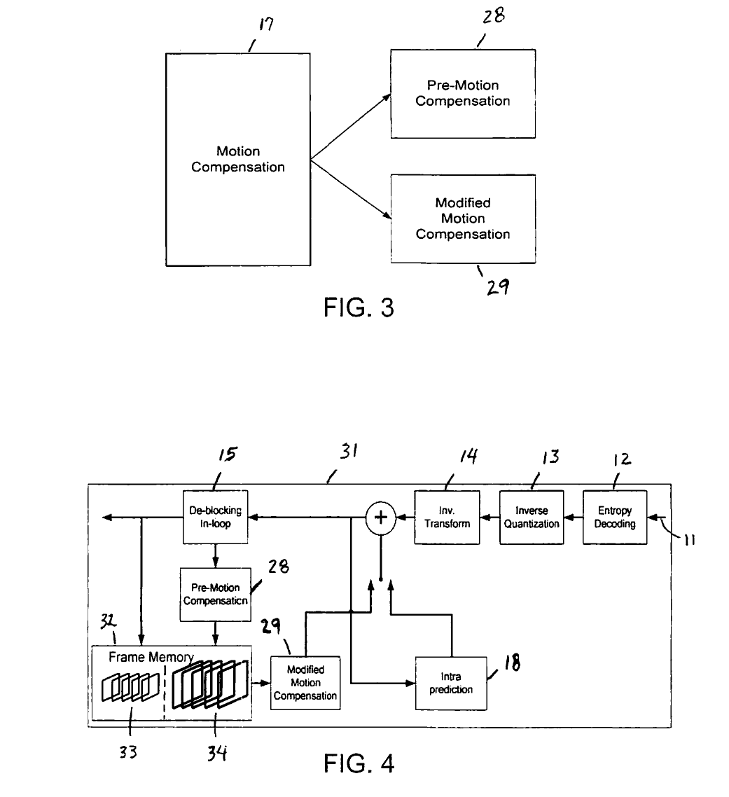

FIG. 3 is an illustrative drawing illustrating the division of the Motion Compensation function of a video decoder into two separate functions in one embodiment of the present invention. In this embodiment, the video decoder is split over two Central Processing Units (CPUs), and the Motion Compensation unit 17 is functionally split into two new units, a Pre-Motion Compensation unit 28 and a Modified Motion Compensation unit 29. The Pre-Motion Compensation unit handles half-pixel interpolation by up-sampling the frame by a factor of two with the de-blocking filter. The Modified Motion Compensation unit utilizes the output data from the Pre-Motion Compensation unit as input in the case of half-pixel and quarter-pixel motion vectors.

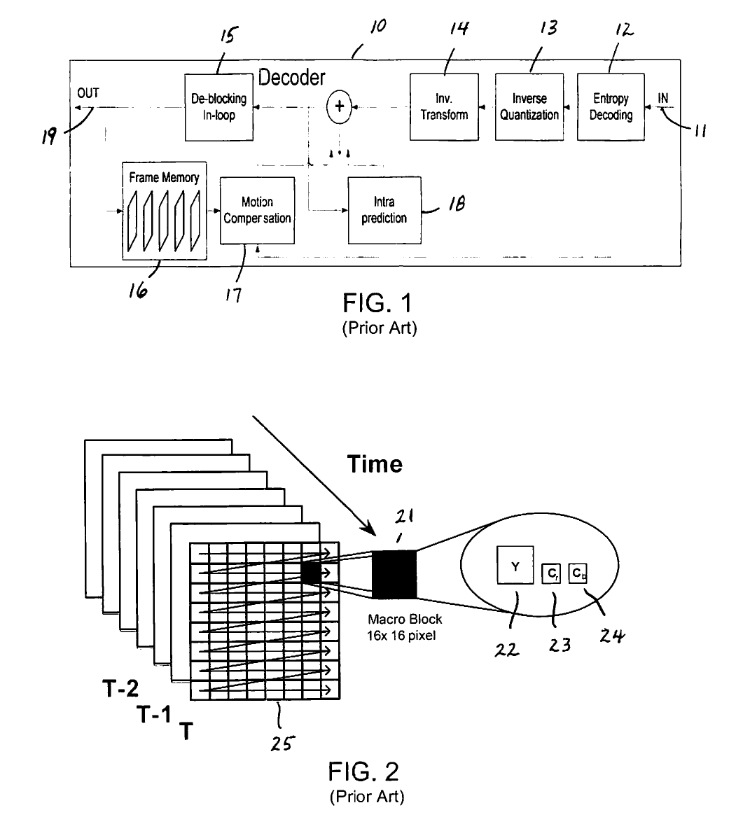

FIG. 4 is a simplified block diagram of an embodiment of the apparatus of the present invention in which the Pre-Motion Compensation unit 28 and the Modified Motion Compensation unit 29 of FIG. 3 have been implemented in a video decoder 31. As in the existing H.264 video decoder, an incoming compressed video signal 11 is processed in the Entropy Decoding unit 12, the Inverse Quantization unit 13, the Inverse Transform unit 14, the Intra Prediction unit 18 or the Modified Motion Compensation unit 29 and then enters a loop with the De-blocking Filter 15. Now, rather than just passing through the prior art Frame Memory 16 (see FIG. 1), the de-blocked data passes through the Pre-Motion Compensation unit 28 and a modified Frame Memory 32. The modified Frame Memory includes a frame buffer 33 for storing original frames and a half-pixel interpolated buffer 34 for storing interpolated reference frames.

The Pre-Motion Compensation unit 28 performs the half-pixel interpolation on the de-blocked data. Preferably, only the half-pixel calculation is performed in the Pre-Motion Compensation unit because this calculation is the most demanding. In the simplest embodiment of the present invention, this calculation is performed on all MBs. Although performing the calculation on all MBs may result in a larger amount of interpolation than for other embodiments, it is not considered a serious drawback because it is done on CPU-2 and thus does not affect the load on CPU-1. The excessive interpolation processing may be avoided by pre-decoding the motion vectors for one or more of the following frames, and only interpolating the blocks that will be used in those frames.

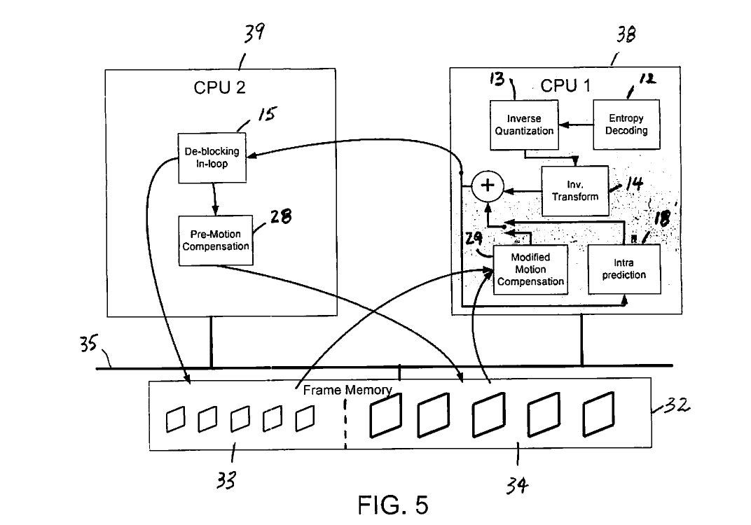

By integrating the pre-motion compensation functionality with the de-blocking functionality, there is no need for the Pre-Motion Compensation unit 28 to read input data from the Frame Memory (as in the H.264 decoder) since the data is already in the CPU cache (if a cache system is used) after the de-blocking step. This reduces the number of external memory accesses, thereby increasing performance and decreasing the load on the memory bus 35 (see FIG. 5).

The pre-motion compensation functionality increases the memory usage for the frame buffers to a factor of five compared to the original H.264 decoder. Thus, the present invention implements both the frame buffer 33 and the half-pixel interpolated buffer 34. The original Motion Compensation Process 17 (see FIG. 3) is modified in the Modified Motion Compensation unit 29 to select between the original and interpolated reference frame buffers. The precision indicated by the motion vector determines whether integer data or interpolated data should be used. Thus, two buffers, one with integer data and one with interpolated subpixel data are utilized. In another embodiment, however, only the half-pixel interpolated buffer is utilized, and if the Motion Vector indicates integer pixel precision, then every second pixel is read instead.

FIG. 5 is a functional block diagram illustrating the processing flow between CPUs in an embodiment of the method of the present invention. In an exemplary embodiment, CPU-1 starts decoding the bit-stream in the Entropy Decoding unit 12, the Inverse Quantization unit 13, and the Inverse Transform unit 14 and stores the decoded data without de-blocking it in memory accessible from both CPU:s. Referring to the video decoding process of FIG. 2, when CPU-1 has decoded MB-line N of a given frame, and one MB from line N+1 of the frame, CPU-2 begins to execute. In CPU-2, the De-blocking Filter 15 initially de-blocks the data and then the Pre-Motion Compensation unit 28 performs half-pixel interpolation. The resulting frame is four times larger than the original one and is stored in the half-pixel interpolated buffer 34, which is used for decoding the next frame.

The de-blocking step is last in the processing chain and can therefore be handled independently before the final output data is stored in the frame buffer 33. Moving this function to CPU-2 does not affect the decoder. The de-blocking filter receives the input data from the first processor and produces de-blocked data. The pre-motion compensation unit performs half-pixel interpolation on the de-blocked data to produce interpolated reference frames.

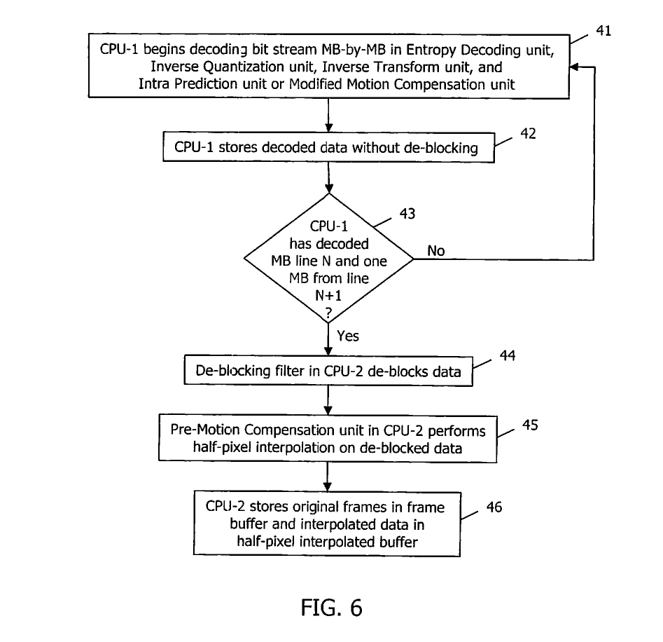

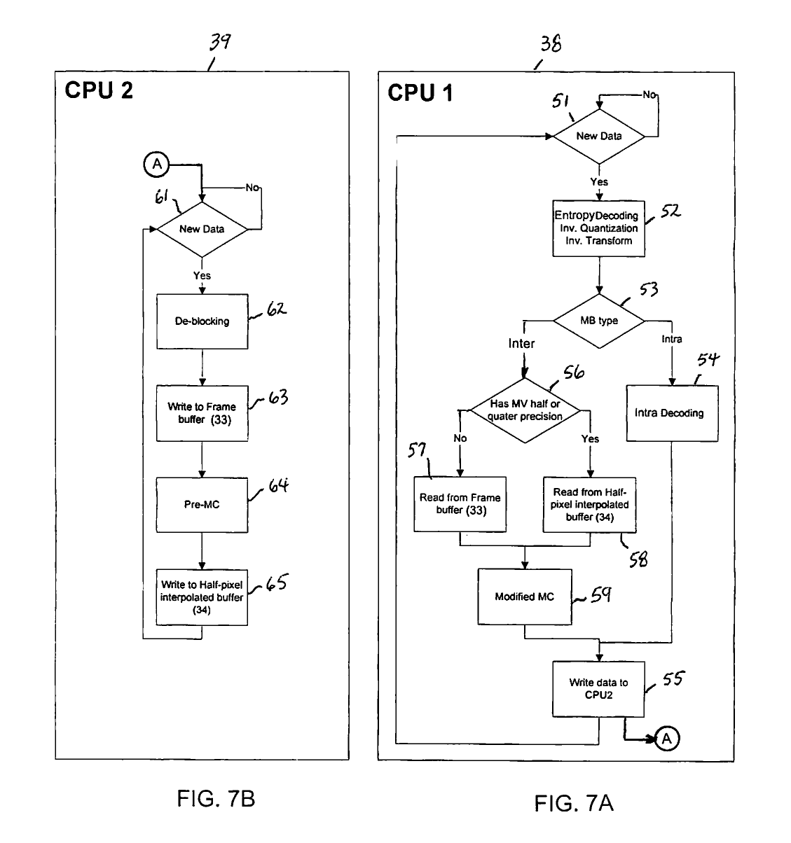

FIG. 6 is a flow chart illustrating the steps of an exemplary embodiment of the method of the present invention. With reference also to FIG. 4, FIG. 6 illustrates a sequential process as a block of data is processed through the decoder 31, but does not reflect the parallelism of the decoding process, as shown in FIGS. 7A-7B below. At step 41, CPU-1 38 starts decoding the bit-stream MB-by-MB in the Entropy Decoding unit 12, the Inverse Quantization unit 13, the Inverse Transform unit 14, and the Intra Prediction unit 18 or the Modified Motion Compensation unit 29 where it selectively reads data from the original and interpolated reference frame buffers to complete the motion compensation function. At step 42, CPU-1 stores the decoded data without de-blocking it. At step 43, it is determined whether CPU-1 has decoded MB-line N of a given frame and one MB from line N+1 of the frame. If not, the method returns to step 41 where CPU-1 continues to decode the bit-stream MB-by-MB. If yes, the method moves to step 44 where the De-blocking Filter 15 in CPU-2 39 begins to de-block the data. At step 45, the Pre-Motion Compensation unit 28 performs half-pixel interpolation on the de-blocked data. At step 46, CPU-2 stores original frames in the frame buffer 33 and stores interpolated reference frames in the interpolated buffer 34.

FIGS. 7A-7B are flow charts illustrating the parallel processes performed in CPU-1 38 and CPU-2 39 in an embodiment of the method of the present invention. Referring first to FIG. 7A, the process in CPU-1 begins at step 51 where it is determined whether new input data has been received. When new input data is received, the process moves to step 52 where CPU-1 performs entropy decoding, inverse quantization, and an inverse transform of the input data. The process then moves to step 53 where it is determined whether the data is to be processed at the inter MB level or intra MB level. If the data is to be processed at the intra MB level, the process moves to step 54 where intra prediction decoding is performed. The process then moves to step 55 where the data is written to CPU-2.

However, if it is determined at step 53 that the data is to be processed at the inter MB level, then the process moves to step 56 where it is determined whether motion vectors are specified with either half-pixel or quarter-pixel accuracy. If not (i.e., the motion vectors are specified with integer accuracy), the process moves to step 57 where CPU-1 38 reads from the frame buffer 33. If the motion vectors are specified with either half-pixel or quarter-pixel accuracy, CPU-1 instead reads from the half-pixel interpolated buffer 34 at step 58. The process then moves to step 59 where modified motion compensation is performed using frames selectively read from either the frame buffer 33 or the half-pixel interpolated buffer 34. The data is then written to CPU-2 39 at step 55.

Referring now to FIG. 7B, data from CPU-1 38 is received at step 61. When new input data is received, the process moves to step 62 where de-blocking is performed. De-blocked data is written to the frame buffer 33 at step 63 and is provided to the pre-motion compensation unit 28 at step 64. The pre-motion compensation unit then writes to the half-pixel interpolated buffer 34 at step 65. The process then returns to step 61 and awaits new input data.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. An apparatus for parallel decoding of a video data stream in a video decoder, comprising:
a first processor for performing a first subset of decoding operations to produce a first intermediate result; and
a second processor for receiving the first intermediate result from the first processor and for utilizing the first intermediate result as an input for performing a second subset of decoding operations in parallel with the first processor to produce a second intermediate result;
wherein the first processor includes means for utilizing the second intermediate result as an input for performing a third subset of decoding operations in parallel with the second processor to produce a decoded video data stream.

2. The apparatus according to claim 1, wherein the first processor includes an entropy decoding unit, an inverse quantization unit, an inverse transform unit, an intra prediction unit, and a modified motion compensation unit for performing the first subset of decoding operations to produce the first intermediate result.

3. The apparatus according to claim 1, wherein the second processor includes a de-blocking filter and a pre-motion compensation unit for performing the second subset of decoding operations, wherein the de-blocking filter is adapted to receive the first intermediate result from the first processor and to produce de-blocked data, and the pre-motion compensation unit performs interpolation on the de-blocked data to produce interpolated reference frames.

4. The apparatus according to claim 3, further comprising a frame memory for storing original video reference frames and the interpolated reference frames, wherein the first processor includes means for selectively providing the original video reference frames or the interpolated reference frames from the frame memory to the modified motion compensation unit for performing modified motion compensation operations on the original video reference frames and the interpolated reference frames.

5. The apparatus according to claim 1, wherein the first processor is adapted to perform the first subset of decoding operations at a macro block (MB) level, wherein the video data stream is decoded MB-by-MB and line-by-line, and the second processor is adapted to begin performing the second subset of decoding operations when the first processor has decoded the MBs from line N and one MB from line N+1.

6. A method of decoding a video data stream in a video decoder, comprising the steps of:
performing a first subset of decoding operations in a first processor to produce a first intermediate result;
sending the first intermediate result to a second processor;
utilizing the first intermediate result by the second processor as an input for performing a second subset of decoding operations in parallel with the first processor to produce a second intermediate result;
sending the second intermediate result to the first processor; and
utilizing the second intermediate result by the first processor as an input for performing a third subset of decoding operations in parallel with the second processor to produce a decoded video data stream.

7. The method according to claim 6, wherein the step of performing a first subset of decoding operations in the first processor includes performing decoding operations with an entropy decoding unit, an inverse quantization unit, an inverse transform unit, an intra prediction unit, and a modified motion compensation unit to produce the first intermediate result.

8. The method according to claim 6, wherein the step of utilizing the first intermediate result by the second processor as an input for performing a second subset of decoding operations includes the steps of:
de-blocking data in the first intermediate result by a de-blocking filter to produce de-blocked data; and
performing interpolation on the de-blocked data by a pre-motion compensation unit to produce interpolated reference frames.

9. The method according to claim 8, wherein the step of sending the second intermediate result to the first processor includes:
storing by the second processor, original video reference frames and the interpolated reference frames in a frame memory which is accessible by the first processor; and
selectively reading by the first processor, either the original video reference frames or the interpolated reference frames from the frame buffer.

10. The method according to claim 9, wherein the step of utilizing the second intermediate result by the first processor as an input for performing a third subset of decoding operations includes performing modified motion compensation operations on the original video reference frames and the interpolated reference frames.

11. The method according to claim 6, wherein the step of performing the first subset of decoding operations in the first processor includes performing the first subset of decoding operations at a macro block (MB) level, wherein the video data stream is decoded MB-by-MB and line-by-line.

12. The method according to claim 6, wherein the step of performing the second subset of decoding operations in the second processor includes beginning the second subset of decoding operations when the first processor has decoded the MBs from line N and one MB from line N+1.
